(19) United States
(12) Patent Application Publication
(10) Pub. No.: US 2025/0175784 A1
(43) Pub. Date: May 29, 2025

(54) SYSTEM AND METHOD FOR MULTI-CARRIER CAPABILITIES ON A SINGULAR INTERNET OF THINGS (IOT) HARDWARE PLATFORM

(71) Applicant: Toyota Material Handling, Inc., Columbus, IN (US)

(72) Inventors: Jennifer Raasch, Seymour, IN (US); James Balmer, Columbus, IN (US); Mark Horne, Indianapolis, IN (US); Paul Mack, Warrenville, IL (US)

(21) Appl. No.: 18/962,217

(22) Filed: Nov. 27, 2024

Related U.S. Application Data
(60) Provisional application No. 63/603,042, filed on Nov. 27, 2023.

(51) Int. Cl. H04W 8/18; H04W 36/00; H04W 88/06

(52) U.S. Cl. CPC H04W 8/183; H04W 36/0011; H04W 88/06

(57) ABSTRACT

Systems and methods for allowing an Internet of Things device to circuit switch among embedded subscriber identity modules (eSIMs) are provided. A communication circuit for operating a plurality of eSIMs may include a first and second eSIM. The communication circuit may further include an eSIM card interface bus configured to provide signals to and from the eSIMs, the bus including a data line adapted to receive a data signal. The communication circuit may further include an eSIM select line configured to receive an eSIM select control signal to select between the eSIMs to communicate with a wireless network. The communication circuit may further include a selector connected to the eSIM select line, the selector adapted to switch the data signal between the first and second channel to provide the data signal to the first and second eSIMs based at least in part on the eSIM select control signal.

### CROSS-REFERENCE TO RELATED APPLICATIONS

This Application claims priority to U.S. Provisional Patent App. No. 63/603,042, filed on Nov. 27, 2023, entitled “SYSTEM AND METHOD FOR MULTI-CARRIER CAPABILITIES ON A SINGULAR INTERNET OF THINGS (IOT) HARDWARE PLATFORM,” the entire disclosure of which is incorporated herein by reference.

### BRIEF SUMMARY

This disclosure generally relates to Internet of Things (IoT) devices. More specifically, this disclosure relates to an IoT device installed in a material handling vehicle having multiple airtime-carrier capabilities on a singular IoT hardware platform.

### BACKGROUND

IoT devices communicate with the Internet and/or other networks to exchange data with other networked devices. Various communication platforms may be available to an IoT device, including, for example, Wi-Fi, a wired network, and a mobile network (for example, a cellular network). A subscriber identity module (SIM), which may include a SIM card, may be provided to the IoT device to access the mobile network. The term “SIM card” may refer, for example, to a physical card. A physical SIM card may be removable and include an integrated circuit (IC) on a plastic carrier. In other examples, the SIM card may be an embedded SIM (eSIM) card that is directly installed on a printed circuit board (PCB) of the IoT device. An eSIM card may be installed during the manufacture of the IoT device. However, communication by conventional IoT devices is limited to the network carriers assigned to a single SIM card installed therein.

There exist mobile devices (for example, cell phones) that are configured to use two SIM cards. However, use of two SIM cards in a mobile device typically involves both SIMs functioning simultaneously, physically or manually switching between SIM cards, or having two different phone numbers respectively associated with each SIM card. There may be a need to switch between wireless carriers due to a loss of wireless signal, based on environmental factors, such as moving outside a wireless coverage area, base station blockages, latency, location, dead zones, etc. The conventional multi-SIM mobile devices do not automatically switch between SIM card usage without human selection or intervention.

### SUMMARY

In an aspect of the present disclosure, a communication circuit for operating a plurality of embedded subscriber identity modules (eSIMs) is disclosed. The communication circuit may include a first eSIM including at least a first eSIM data signal input and a second eSIM including at least a second eSIM data signal input. The communication circuit may further include an eSIM card interface bus designed to provide signals to and from the first eSIM and the second eSIM. The eSIM card interface bus may include a data line designed to receive a data signal. The communication circuit may further include an eSIM select line adapted to receive an eSIM select control signal to select between using the first eSIM or the second eSIM to communicate with at least one wireless network. The communication circuit may further include a selector operatively connected to the eSIM select line. The selector may be associated with a first channel and a second channel. The selector may be adapted to switch a connection of the data signal between the first channel and the second channel to provide the data signal to the first eSIM data signal input and the second eSIM data signal input based at least in part on the eSIM select control signal.

In some instances, the communication circuit may further include a logic level shifter designed to condition the eSIM select control signal. In some aspects, the communication circuit may further include a resistor-transistor logic circuit designed to condition the eSIM select control signal. In some aspects, the first eSIM may further include a first eSIM reset signal input and a first eSIM clock signal input. The second eSIM may further include a second eSIM reset signal input and a second eSIM clock signal input. The eSIM card interface bus may further include a reset signal line designed to receive a reset signal and a clock line designed to receive a clock signal. Each of the eSIM card interface bus, the first eSIM, and the second eSIM may be designed to respectively receive the reset signal and the clock signal. In some aspects, the first eSIM and the second eSIM are each a machine-to-machine form factor eSIM.

In another aspect of the present disclosure, a method of switching among a plurality of subscriber identity modules (SIMs) in an Internet of Things (IoT) device is disclosed. The method may include obtaining a first cellular signal strength associated with a first wireless communications session over a first network via a first wireless carrier and a first SIM of the plurality of SIMs. The method may further include resetting a counter when the first cellular signal strength is equal to or above a threshold cellular signal strength and incrementing the counter when the first cellular signal strength is below the threshold cellular signal strength. The method may also include maintaining the first wireless communications session using the first SIM when the counter is below a counter threshold and determining availability of a second SIM of the plurality of SIMs when the counter is equal to the counter threshold. The method may also include initiating a process to establish a second wireless communications session over a second network using the second SIM when the second SIM is available and the counter is equal to the counter threshold.

In some aspects, the method may further include determining whether the first cellular signal strength associated with the first network is greater than or equal to the threshold cellular signal strength. In some instances, incrementing the counter when the first cellular signal strength is below the threshold cellular signal strength may further include determining that the counter is below the counter threshold and obtaining a second cellular signal strength associated with the first wireless communications session based at least in part on the counter being below the counter threshold. In other aspects, determining that the counter is below the counter threshold is at a first time and incrementing the counter when the first cellular signal strength is below the threshold cellular signal strength may further include determining that the counter is below the counter threshold at a second time later than the first time, and obtaining a third cellular signal strength associated with the first wireless communications session over the first network based at least in part on the counter being below the counter threshold.

In some examples, initiating the process to establish the second wireless communications session over the second network using the second SIM may further include determining that a handover to the second wireless communications session over the second network using the second SIM is not possible at a first time, and outputting an error notification indicating that the handover to the second wireless communications session over the second network using the second SIM is not possible at the first time. In some aspects, initiating the process to establish the second wireless communications session over the second network using the second SIM may further include determining that the handover to the second wireless communications session over the second network using the second SIM is possible at a second time, wherein the second time is later than the first time, and establishing the second wireless communications session over the second network using the second SIM when the second SIM based on the handover to the second wireless communications session being possible at the second time.

In additional examples, the method may further include establishing the first wireless communications session with the first network using the first SIM and registering the first SIM with the first network. In some aspects, obtaining the first cellular signal strength may further include waiting for an allotted time to expire before obtaining the first cellular signal strength, the allotted time being a period of time associated with establishing the first wireless communications session with the first network. In some aspects, the allotted time is 2.5 minutes.

In some aspects, the first wireless carrier is of a plurality of wireless carriers, and wherein initiating the process to establish the second wireless communications session over the second network using the second SIM may further include selecting a second wireless carrier from the plurality of wireless carriers based at least in part on a one or more of a predetermined selection, an arbitrary selection, an availability of each of the plurality of wireless carriers, and a preferred roaming list associated with the plurality of wireless carriers. In some aspects, each of the plurality of SIMs is an eSIM. In some aspects, a selection order of the plurality of SIMs is arbitrary.

In another example of the present disclosure, an IoT device is disclosed. The IoT device may include at least one transceiver adapted to transmit and receive wireless communication signals over at least one wireless communications session. The IoT device may further include a communication circuit in communication with the at least one transceiver, wherein the communication circuit is adapted to operate a plurality of eSIMs associated with the at least one wireless communications session. The communication circuit may include a first eSIM including at least a first eSIM data signal input and a second eSIM including at least a second eSIM data signal input. The communication circuit may further include an eSIM card interface bus adapted to provide signals to and from the first eSIM and the second eSIM, the eSIM card interface bus comprising a data line adapted to receive a data signal. The communication circuit may further include an eSIM select line adapted to receive an eSIM select control signal adapted to select between using the first eSIM or the second eSIM to communicate with at least one wireless network. The communication circuit may further include a selector operatively connected to the eSIM select line, the selector being associated with a first channel and a second channel. The selector may be adapted to switch a connection of the data signal between the first channel and the second channel to provide the data signal to the first eSIM data signal input and the second eSIM data signal input based at least in part on the eSIM select control signal.

In some aspects, the first eSIM may further include a first eSIM reset signal input and a first eSIM clock signal input, the second eSIM may further include a second eSIM reset signal input and a second eSIM clock signal input, the eSIM card interface bus may further include a reset signal line designed to receive a reset signal and a clock line designed to receive a clock signal, and each of the eSIM card interface bus, the first eSIM, and the second eSIM is designed to respectively receive the reset signal and the clock signal. In some examples, the IoT device includes a material handling vehicle.

In another example of the present disclosure, an apparatus for switching among a plurality of SIMs in an IoT device is disclosed. The apparatus may include means for obtaining a first cellular signal strength associated with a first wireless communications session over a first network via a first wireless carrier and a first SIM of the plurality of SIMs. The apparatus may further include means for resetting a counter when the first cellular signal strength is equal to or above a threshold cellular signal strength and incrementing the counter when the first cellular signal strength is below the threshold cellular signal strength. The apparatus may also include means for maintaining the first wireless communications session using the first SIM when the counter is below a counter threshold and determining availability of a second SIM of the plurality of SIMs when the counter is equal to the counter threshold. The apparatus may further include means for a process to establish a second wireless communications session over a second network using the second SIM when the second SIM is available and the counter is equal to the counter threshold.

In another aspect of the present disclosure, an apparatus for switching among a plurality of SIMs in an IoT device is disclosed. The apparatus may include one or more memories storing processor-executable code and one or more processors coupled with the one or more memories. The one or more processors may be individually or collectively operable to execute the code to cause the apparatus to obtain a first cellular signal strength associated with a first wireless communications session over a first network via a first wireless carrier and a first SIM of the plurality of SIMs. The one or more processors may be further individually or collectively operable to execute the code to cause the apparatus to reset a counter when the first cellular signal strength is equal to or above a threshold cellular signal strength and incrementing the counter when the first cellular signal strength is below the threshold cellular signal strength. The one or more processors may be further individually or collectively operable to execute the code to cause the apparatus to maintain the first wireless communications session using the first SIM when the counter is below a counter threshold and determining availability of a second SIM of the plurality of SIMs when the counter is equal to the counter threshold. The one or more processors may be further individually or collectively operable to execute the code to cause the apparatus to initiate a process to establish a second wireless communications session over a second network using the second SIM when the second SIM is available, and the counter is equal to the counter threshold.

### BRIEF DESCRIPTION OF DRAWINGS

FIG. 1 illustrates a wireless communications system according to an example;

FIG. 2 is a circuit diagram of an example communication circuit for an IoT device according to an example;

FIG. 3 is a flowchart of an example method for switching among a plurality of subscriber identity modules according to an example;

FIG. 4 is a schematic view of an example IoT device according to an example; and

FIG. 5 is a flow diagram describing an example method for switching among a plurality of subscriber identity modules according to an example.

### DETAILED DESCRIPTION

The following discussion is presented to enable a person skilled in the art to make and use examples of the invention. Various modifications to the illustrated examples will be readily apparent to those skilled in the art, and the generic principles herein can be applied to other examples and applications without departing from examples of the invention. Thus, examples of the invention are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the invention.

Before any examples of the invention are explained in detail, it is to be understood that the invention is not limited in its application to the details of construction and the arrangement of components set forth in the following description or illustrated in the attached drawings. The invention is capable of other examples and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

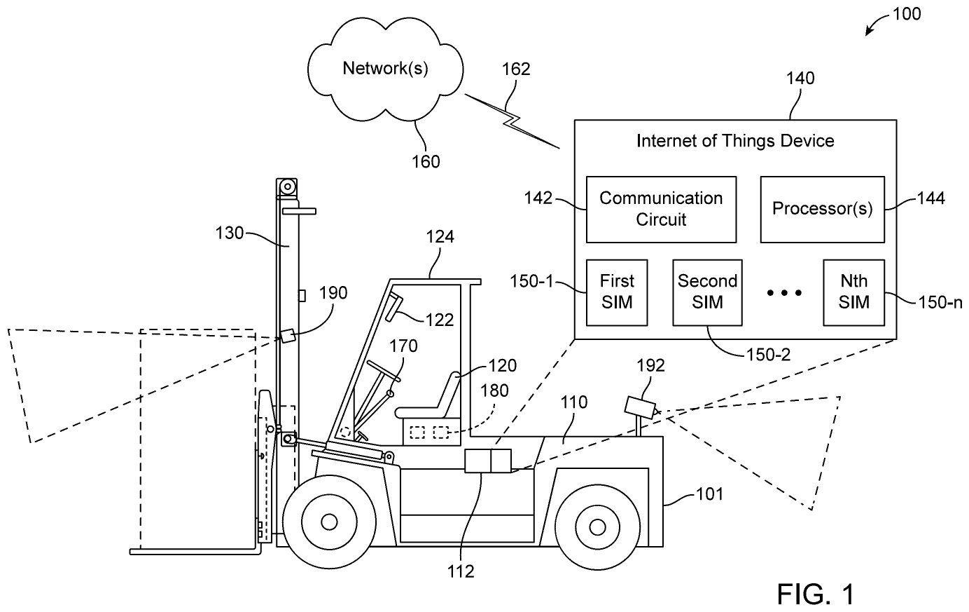

FIG. 1 illustrates a wireless communications system 100 according to one example. The wireless communications system 100 may include one or more material handling vehicles 101 each having an IoT device 140 and one or more networks 160. In some examples, the IoT device 140 may be provided in the form of a telematics unit or similar device. The material handling vehicle 101 may include an IoT device 140 or may itself be considered to be an “IoT device.” An IoT device 140 may be sensors, actuators, gadgets, appliances, or machines, which may be embedded in other devices, like mobile devices such as the material handling vehicle 101, industrial equipment, or the like. The IoT device 140 may be capable of wireless or wired communications with the one or more networks 160 over one or more communication links 162.

In some examples, the IoT device 140 may be an Internet of Everything (IoE) device, or a machine type communications (MTC) device, among other examples, which may be implemented in various objects such as appliances, or vehicles, meters, among other examples. The IoT devices 140 described herein may be able to communicate with various types of devices, such as other IoT devices 140 that may sometimes act as relays, as well as network entities associated with the one or more networks 160. In some examples, the network 160 may be connected to the Internet.

The wireless communications system 100 may further include one or more devices, such as one or more network devices (e.g., network entities), a plurality of IoT devices 140, and a core network. In some examples, the wireless communications system 100 may be a Long Term Evolution (LTE) network, an LTE-Advanced (LTE-A) network, an LTE-A Pro network, a New Radio (NR) network, an Ethereum Network (Eth), a Wi-Fi network, or a network operating in accordance with other systems and radio technologies, including future systems and radio technologies not explicitly mentioned herein. The network entities may include a NodeB, an eNodeB (eNB), a next-generation NodeB or giga-NodeB (either of which may be referred to as a gNB), a Home NodeB, a Home eNodeB, or some other suitable terminology including macro eNBs or gNBs, small cell eNBs or gNBs, or relay base stations, among other examples. In other examples, the network entities may include an access point. In some examples, a carrier may support multiple cells, and different cells may be configured according to different protocol types (e.g., machine-type communication (MTC), narrowband Internet-of-Things (NB-IoT), enhanced mobile broadband (eMBB), or others).

In some examples, the loT device 140 may be a low cost or low complexity device and may provide for automated communication between machines (e.g., via Machine-to-Machine (M2M) communication). M2M communication or MTC may refer to data communication technologies that allow devices to communicate with one another or a network entity (e.g., a base station or an access point) without human intervention. In some examples, M2M communication or MTC may include communications from devices that integrate sensors or meters to measure or capture information and relay such information to a central server or application program that uses the information or presents the information to humans interacting with the application program. Some IoT devices 140 may be designed to collect information or enable automated behavior of machines or other devices. Examples of applications for MTC devices include smart metering, inventory monitoring, inventory stocking and loading, supply chain management, equipment monitoring, safety monitoring, fleet management and tracking, remote security sensing, physical access control, asset tracking, and many other applications.

In some examples, the loT device 140 may be configured to support communicating directly with other the IoT devices 140 via a device-to-device (D2D) communication link (e.g., in accordance with a peer-to-peer (P2P), D2D, sidelink protocol, or other protocols). In some examples, one or more loT devices 140 of a group of the IoT devices 140 that are performing D2D communications may be within a coverage area of a network entity (e.g., a base station, an access point, a radio unit, etc.) of the network 160, which may support aspects of such D2D communications being configured by (e.g., scheduled by) the network entity. In some examples, one or more IoT devices 140 of such a group may be outside the coverage area of a network entity or may be otherwise unable to or not configured to receive transmissions from a network entity. In some examples, groups of the IoT devices 140 communicating via D2D communications may support a one-to-many (1:M) system in which each IoT device 140 transmits to each of the other the IoT devices 140 in the group. In some examples, a network entity may facilitate the scheduling of resources for D2D communications. In some other examples, D2D communications may be carried out between the IoT devices 140 without an involvement of a network entity.

In some systems, a D2D communication link may be an example of a communication channel, such as a sidelink communication channel, between vehicles (e.g., IoT devices 140). In some examples, material handling vehicles 101 may communicate using vehicle-to-everything (V2X) communications, vehicle-to-vehicle (V2V) communications, or some combination of these. A material handling vehicle 101 may signal information related to traffic conditions, signal scheduling, weather, safety, emergencies, inventory, or any other information relevant to a V2X system. In some examples, the material handling vehicles 101 in a V2X system may communicate with roadside infrastructure, such as roadside units, or with the network via one or more network nodes (e.g., network entities, base stations, RUs, access points, etc.) using vehicle-to-network (V2N) communications, or with both. In some examples, the material handling vehicles 101 in a V2X system may communicate with one or more network devices within a warehouse, which may include near-field communication devices, such as radio frequency identification (RFID) tags, which may be used to identify locations within the warehouse.

The IoT device 140 may wirelessly communicate with other devices using the network 160 via one or more communication links 162 (e.g., an access link) using resources associated with one or more carriers. The term “carrier” may refer to a set of radio frequency (RF) spectrum resources having a defined physical layer structure for supporting the communication links 162. For example, a carrier used for a communication link 162 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Communication between a network 160 and other devices may refer to communication between the devices and any portion (e.g., entity, sub-entity) of a network 160. For example, the terms “transmitting,” “receiving,” or “communicating,” when referring to a network 160, may refer to any portion of a network 160 or a network entity (e.g., a base station, a central unit, a distributed unit, a RU, etc.) of a radio access network communicating with another device (e.g., directly or via one or more other network entities).

Although a single material handling vehicle 101 with a single IoT device 140 is shown in FIG. 1, other examples of the wireless communications system 100 may include additional material handling vehicles 101 with additional IoT devices 140. Some examples may further include other IoT devices 140 not associated with a material handling vehicle 101. The various material handling vehicles 101 with their associated IoT devices 140 and the other IoT devices 140 may form a local network of IoT devices 140. In some examples, the material handling vehicles 101 and the IoT devices 140 may be in, around, or near one or more warehouses.

The IoT device 140 may include at least two SIM cards 150-1, 150-2, through 150-n (collectively referred to herein as SIM cards 150). As used herein, the terms “SIM card” and “SIM” may be interchangeable, regardless of whether the SIM is a physical card or an embedded SIM. The SIM cards 150 may be physical SIM cards or embedded SIM cards. Each of the SIM cards may be associated with a wireless network or a wireless carrier. A SIM card 150 may store an International Mobile Subscriber Identity (IMSI) and related keys for authentication to one or more wireless networks or wireless carriers. Each SIM card 150 may maintain device or user identity and security across various mobile networks. In some examples, the SIM cards 150 may be small, removable smart cards used in an IoT device 140, a mobile phone, or other devices. The SIM cards 150 may enables the IoT device 140 or other device to connect to a mobile network, allowing the IoT device 140 to send data, receive information, and access mobile data services. Each SIM card 150 may include information such as a device identification number, a phone number, network authorization data, and personal security keys. In some examples, the It also provides a storage area for contacts and messages, depending on its capacity. The SIM cards 150 may be provided in various sizes, including standard, micro, and nano, to accommodate different device designs. In some examples, the SIM cards 150 may be embedded SIM cards, which may be built on a circuit of the IoT device 140.

The IoT device 140 may further include one or more processors 144 and a communication circuit 142. The one or more processors 144 and a communication circuit 142 may support wireless communications capabilities of the IoT device 140. The one or more processors 144 and the communication circuit 142 may support wireless communications capabilities of the IoT device 140 using the two or more SIM cards 150. The communication circuit 142 may support switching a wireless communications session established with a first network of the networks 160 using a first SIM card 150, such as the SIM card 150-1, to a second network of the networks 160 using a second SIM card 150, such as the SIM card 150-2.

FIG. 1 shows a side elevational view of the example material handling vehicle 101. The material handling vehicle 101 may include a body 110, an operator cab 124, a driver's seat 120, a mast 130, a processor 112, one or more feedback devices 180, one or more display modules 122, and a control module 170. In some example examples, the material handling vehicle 101 may be operated by a driver who sits in the driver's seat 120. However, in other examples, the material handling vehicle 101 can operate autonomously or via remote control. In the manual driver operation form, the driver can use the control module 170 to control the material handling vehicle 101, and the control module 170 may be provided in the form of a control lever. For example, the control module 170 may be used to shift the material handling vehicle 101 into forward or backward motions. It will be appreciated that the material handling vehicle 101 may include additional, or fewer, control levers or instruments which the driver may use to control the material handling vehicle 101.

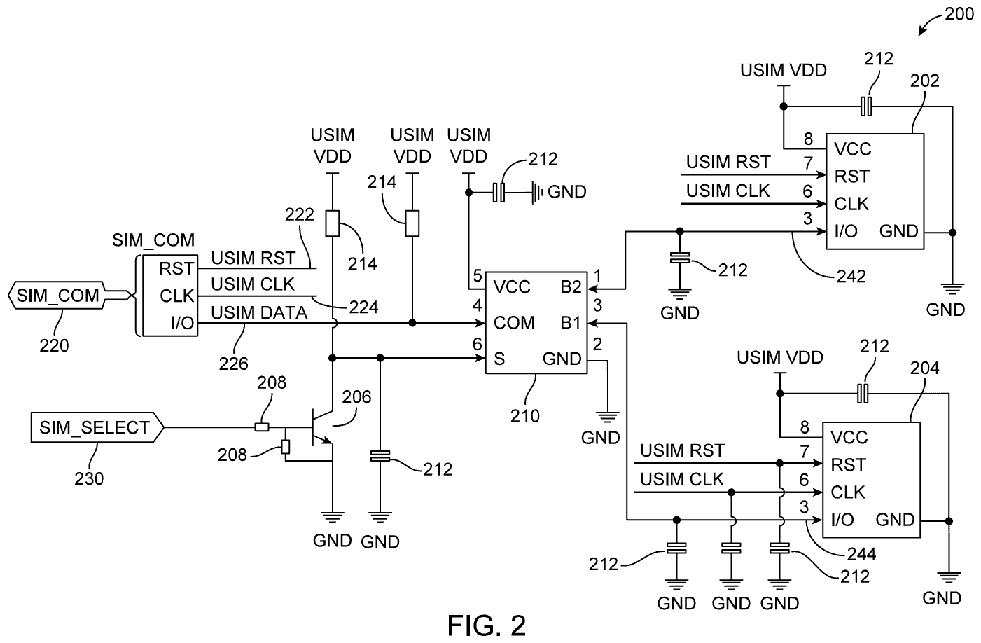

The material handling vehicle 101 may further include a vision system that may include the processor 112, one or more front facing sensors 190, and one or more rear facing sensors 192. The processor 112, the front facing sensor 190, the rear facing sensor 192, and the feedback device 180 may be in communication with one another and may exchange information via a wired or wireless configuration. In an example, the processor 112 may include the circuit 200 of FIG. 2, although the circuit 200 for switching between SIMs may be provided elsewhere in example examples. In some example examples, the vision system may include its own processor, and the vision system and the feedback devices 180 may be modular with respect to the material handling vehicle 101. In some forms, the material handling vehicle 101 can include an onboard control system that is separate from an IoT-enabled control system or controller.

It is to be understood that although FIG. 1 shows the material handling vehicle 101 as a counterbalance-type forklift truck, this is not to be considered limiting. The material handling vehicle 101 may be provided in the form of any material handling vehicle or other vehicle used to transport materials. For example, the material handling vehicle 101 may be provided in the form of a reach truck, a stacker, a pallet truck, or an order picker, for example.

Accordingly, the vision system and the feedback devices 180 may be removably coupled to the material handling vehicle 101 and the processor 112 (or other control system or controller) of the material handling vehicle 101. In this way, the vision system and the feedback devices 180 may be retrofit onto a number of different types of material handling vehicles. The feedback devices 180 may also be configured to alert the driver by auditory, visual, and/or tactile means provided in the form of sirens, horns, announcements, lights, strobes, images, vibrations, deacceleration, and/or pulsations. The feedback device 180 may, in some instances, display data or an alert on the display module 122.

The front facing sensor 190 and the rear facing sensor 192 may be provided in the form of one or more cameras, laser scanners, accelerometers, gyro sensors, proximity sensors, radars, lidars, optical sensors (for example, infrared sensors, photoelectric sensors, etc.), acoustic sensors, barometers, thermometers, or other suitable sensors or any combination thereof. The front facing sensor 190 may be positioned to sense the environment in front of the material handling vehicle 101 and may be attached to the mast 130 or another portion of the front end of the material handling vehicle 101. The rear facing sensor 192 may be positioned to sense the environment behind the material handling vehicle 101 and may be positioned on or adjacent the rear end of the body 110, for example.

The front facing sensor 190 and the rear facing sensor 192 may sense various parameters of the environment surrounding the material handling vehicle 101, such as visual, auditory, or other environmental features. One or more of the front facing sensor 190 and the rear facing sensor 192 may also be configured to generate sensor data and may communicate the corresponding sensor data with the processor 112 of the material handling vehicle 101. For example, the front facing sensor 190 and the rear facing sensor 192 may capture still or continuous images and provide the corresponding image data to the processor 112 for analysis. The processor 112 may also send control signals to activate the feedback device 180 based on the analysis performed on the sensor data from the front facing sensor 190 and the rear facing sensor 192. The feedback device 180 may provide notifications in the form of auditory, visual, tactile sensory, or a combination thereof. The notifications may be provided in the form of various alarms that alert the operator of the material handling vehicle 101 as to conditions of the surrounding environment. The feedback device 180 may be positioned in a number of locations, such as the seat 120, the operator cab 124, or anywhere else on the body 110, to facilitate notifying the operator or surrounding persons. Any of the described data, alerts, images, notifications, or the like described herein may be communicated to the one or more networks 160 via the IoT device 140.

Techniques and systems described herein provide IoT devices 140 that may switch between SIM cards 150 associated with different wireless carriers to communicate on any available cellular or mobile network 160. For example, the IoT device 140 may communicate over any cellular or mobile network 160 that has coverage in the geographical region in which the IoT device 140 is located. Techniques described herein enable the IoT device to, for example, dynamically and without human intervention or additional external hardware, handover communications from one network 160 via a first SIM card 150-1 to a second network 160 via a second SIM card 150-2. The handovers may be performed upon consecutive instances of poor signal strength. This may result at least in greater connectivity, improved communications, less lag time, improved user experience, reduced numbers of collisions involving the material handling vehicle 101, and improved inventory management.

FIG. 2 is a circuit diagram of an example communication circuit 200 for an IoT device according to an example. The communication circuit 200 may be implemented by an IoT device or a material handling vehicle or its components as described herein, such as the IoT device 140 or the material handling vehicle 101 of FIG. 1. In this non-limiting example, the circuit 200 may be provided in the form of a circuit board, such as a printed circuit board (PCB) or a system-on-a-chip (SoC) installed on the IoT-enabled controller of the material handling vehicle 101. The communication circuit 200 includes two SIMs, a first SIM 202 and a second SIM 204, which may be aspects or examples of the SIM cards 150 of FIG. 1.

The communication circuit 200 may receive multiple signals on an eSIM card interface bus SIM_COM 220 for operating at least one of the eSIM cards, for example, the first SIM 202 and/or the second SIM 204. The first SIM 202 and the second SIM 204 may be provided in the form of a machine-to-machine form factor (MFF2) eSIM, which may be mounted on a PCB. The eSIM card interface bus SIM_COM 220 may include a reset signal RST on a reset signal line USIM_RST 222, a clock signal CLK on a clock line USIM_CLK 224, and a data signal input/output (I/O) on a data line USIM_DATA 226. In some forms, the data signal I/O may be provided from an external source, for example, from a wireless telecommunications device, a receiver, transmitter, or transceiver, or one or more processors. The communication circuit 200 may also receive a SIM select control signal S on a SIM select line SIM_SELECT 230, for example, from an external source or from a main system control unit (for example, the one or more processors 144 of FIG. 1, a truck controller, a networked control system, etc.).

The SIM select control signal S may be received via the SIM select line SIM_SELECT 230, and may be conditioned, for example, by a logic level shifter or a resistor-transistor logic (RTL) configured transistor, for example, transistor 206, after which the SIM select control signal S (via the SIM select line SIM_SELECT 230) may operate (for example, enable or command) a selector 210. The selector 210 may be, for example, a switch or a multiplexor. In an example, a NEXPERIA® PDTC143ZU NPN resistor-equipped transistor (RET) may be used for the transistor 206, which may include two bias resistors 208 in the non-limiting example illustrated in FIG. 2. In an example, a Texas Instruments™ SN74LVC1G3157 single-pole double-throw analog switch may be used for the selector 210, but examples are not limited thereto.

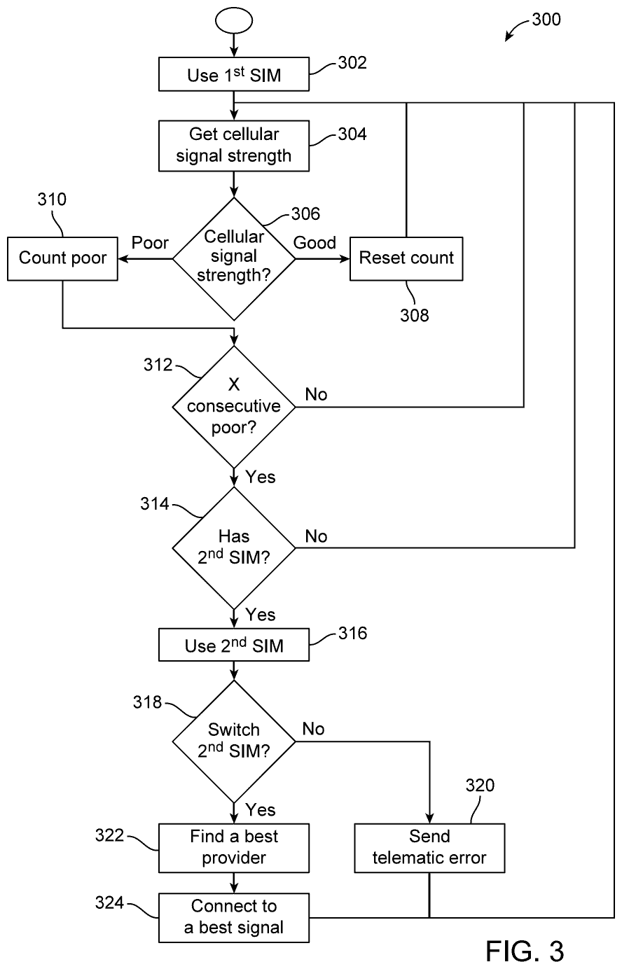

The selector 210 may receive a data signal via the data line USIM_DATA 226 from the eSIM card interface bus SIM_COM 220. The selector 210 may be connected to data signal I/O inputs of two or more eSIM devices. For example, the selector 210 may provide the data signal to a first eSIM data signal input 242 of the first SIM 202. Likewise, the selector 210 may provide the data signal to a second eSIM data signal input 244 of the second SIM 204. The selector 210 may allow the data signal received via the data line USIM_DATA 226 to be passed through to the corresponding eSIM data signal input 242 and 244 of only one of the SIMS 202 or 204, respectively, at a time based on the SIM select control signal S. For example, when the SIM select control signal S selects the first SIM 202 to be operational, the selector 210 may provide the data signal to the first eSIM data signal input 242 of the first SIM 202. Similarly, when the SIM select control signal S selects the second SIM 204 to be operational, the selector 210 may provide the data signal to the second eSIM data signal input 244 of the second SIM 204. In some examples, the SIM select control signal S may be set either high or low based on the output of a selection process described in more detail in connection with FIG. 3.

In some forms, the SIM select control signal S may be connected to a base of a transistor that acts as a SELECT pin to a single-pole double-throw analog switch. One of the throws of the transistor may be “closed” based on whether the volage of the SELECT pin is 0 volts (V) or 1.8 V. In other examples, other threshold voltages may be set based on specifications of a processor and/or the component used. When one of the throws is closed, the I/O pin on the eSIM is set to either high or low, which may activate the eSIM. When the SIM select control signal S is high the first SIM 202 may be selected, and the data signal may pass through the selector 210 and output from a first channel B2 of the selector 210 and received at the data signal input 242 of the first SIM 202. When the SIM select control signal S is low, the second SIM 204 may be selected, and the data signal may pass through the selector 210 and output from a second channel BI of the selector 210 and received at the second eSIM data signal input 244 of the second SIM 204. Other examples besides the one shown in FIG. 2 are contemplated.

The reset RST 222 and clock CLK signals 224 from the eSIM card interface bus SIM_COM 220 may be respectively connected to the corresponding inputs to the SIM 202 and 204, such that each SIM 202 and 204 may receive the respective reset RST and clock CLK signals at the same time. In this non-limiting example, the unselected eSIM may react passively to the duplicate reset and clock signals, but not influence system operation or participate in wireless network engagement because its data signal is deselected, thus keeping the SIM isolated from the rest of the system.

Examples of power and signal bypassing or filtering are also illustrated in the communication circuit 200 of FIG. 2. For example, capacitors 212 may be connected between respective signal lines and ground GND, and pull-up resistors 214 may be connected between the power USM_VDD, and respective signal lines may be included. While FIG. 2 illustrates the first SIM 202 and the second SIM 204 being eSIMs, a communication circuit in accordance with an example may provide switching between eSIMs, removeable SIM cards, or any combination thereof.

FIG. 3 illustrates a selection process 300 for selecting and/or using a first SIM among multiple SIMs for wireless communications. For example, the selection process 300 may be used to switch or otherwise select between a first SIM and a second SIM, such as the first SIM card 150-1 and the second SIM card 150-2 of FIG. 1, or the first SIM 202 or the second SIM 204 of FIG. 2. The SIMs may be physical cards, eSIMs, or a combination thereof. In an example, each of the plurality of SIMs may be an eSIM. The operations of the selection process 300 may be implemented by a loT device or its components as described herein. For example, the operations of the selection process 300 may be performed by a IoT device 140 as described with reference to

FIG. 1, including the communication circuit 142 of FIG. 1. I other examples, the operations of the selection process 300 may be performed by the communication circuit 200 as described with reference to FIG. 2. In some examples, the communication circuit 142, or the communication circuit 200 may execute a set of instructions to control the functional elements of the IoT device 140 to perform the described functions of the selection process 300. Additionally, or alternatively, the communication circuit 142, or the communication circuit 200 may perform aspects of the described functions using special-purpose hardware.

At 302, a first SIM is used for wireless communications. In some aspects, the selection order of the SIMs may be arbitrary, where any of the SIMs may be selected as the “first SIM,” “the second SIM,” and the like. In another example, the first SIM may be preselected or there may be a priority selection among the SIMs. In some forms, the priority selection for the first SIM may be provided in the form of a priority list with one or more parameters that may be predetermined, predefined, or otherwise updated. In some examples, the first SIM may be used for a currently established communications session with a first network, such as one or more networks 160 of FIG. 1, associated with a first wireless carrier. In other examples, the first SIM may be used to attempt to establish a wireless communications session with the first network. For illustrative purposes only, the selection process 300 is described as selecting the first SIM 202 of FIG. 2, which may correspond to the first SIM card 150-1 of FIG. 1, although in other examples, other of the SIM cards 150 may be selected as the first SIM.

At 304, a cellular signal strength for the first network associated with a first wireless carrier that is associated with the first SIM 202. In some examples, the cellular signal strength may be based on a received signal strength indicator (RSSI), a reference signal received power (RSRP), a reference signal received quality (RSRQ), or any other indicator of cellular signal strength. In some examples, the cellular signal strength may be based on a reference signal received at the IoT device or on a sounding reference signal transmitted by the IoT device. In other examples, the signal strength may be for a different type of network, such as a Wi-Fi network.

In some examples, determining the cellular signal strength at 304 may be based on attempting to register to the first network. This may be, for example, when the IoT device is performing a cell search to detect the first network, such as a base station of the first network. The selection process 300 may be allotted a time duration for the cellular signal strength to be determined or for a communication session to be established with the first network. In an example, the allotted time to attempt to connect to the first network and/or determine the signal strength may be 2.5 minutes, although the allotted time may be shorter or longer. Obtaining the cellular signal strength at 304 may be performed, for example, periodically, cyclically, on a schedule, or upon an initialization of the IoT device. In other examples, the cellular signal strength may be obtained based on a threshold number of errors received in either the received or transmitted signals, a detected lag in communications, an indication of poor signal quality from a user, an instruction from the network, a location of the IoT device (e.g., such as the IoT device approaching the edge of a coverage area of a base station of the network or approaching an identified dead zone), or another trigger.

At 306, the selection process 300 may include determining whether the cellular signal strength for the first network is “Good” or “Poor.” The determination of whether the cellular signal strength may be “Good” or “Poor” may be based on comparing the signal strength to a signal strength threshold. For example, when the cellular signal strength is equal to or above the signal strength threshold, the cellular signal strength may be designated as “Good.” Likewise, when the cellular signal strength is below the signal strength threshold, the cellular signal strength may be designated as “Poor.”

The signal strength threshold may be set for an individual IoT device, which may be based on one or more factors such as location, availability of more than one network, network strength, distance to one or more base stations or access points, transmit power of the IoT device, identification of dead zones, the presence of any signal boosters, the number of other IoT devices within the network, current weather conditions, a mission critical status, the importance of the data to be communicated over the network, a subscription status, a subscription cost, and the like. Further, the signal strength threshold may change over time for an IoT device based on the one or more factors.

In some examples, the determination of whether the signal strength is “Good” or “Poor” may be based at least in part on whether the allotted time expires. In some examples, if no communication session is established within the allotted time, the signal strength may be designated as “Poor,” and the selection process 300 may proceed to 310.

However, if a connection to the first network is achieved before the allotted time expires, the signal strength may be designated as “Good” and the selection process 300 proceeds to 308. At 308, a counter may be reset to zero. While the communications session is in progress, the selection process 300 may continue to periodically check the cellular signal strength at 304. For example, a domain name system (DNS) server may be pinged periodically to validate whether the signal strength is equal to or above the signal strength threshold. In some examples, the DNS server may be pinged every 30 seconds, although in other examples, other time durations may be used. In other examples, the IoT device may determine the cellular signal strength based on a received power, one or more reference signals from the network, a number of errors in the received signals, and the like. In some examples, a Wi-Fi handler may also scan for an available network at 308 or 310.

As long as the selection process 300 determines that the signal strength is “Good,” the selection process may continue to reset the counter and test the cellular signal strength. However, once the signal strength is determined to be “Poor” because the signal strength is below the threshold, the selection process 300 may proceed to 310 and the counter is incremented. For example, the counter may be increased by one each time the signal strength is determined to be below the signal strength threshold.

At 312, the selection process 300 may compare the counter to a counter threshold. The selection process 300 may compare the counter to a counter threshold in order to determine whether the communications session should be changed to another network when the signal strength has been “Poor” for too long. For example, the selection process 300 may determine that the communications session should be changed to another network when the counter has shown the signal strength to be poor a consecutive number of times. In one example, the counter threshold may be two, which would indicate 2 consecutive “Poor” signal strength determinations. However, other examples of the counter threshold may be one (1), three (3), or a larger number. The counter threshold may be set based on any of the factors described above for the signal strength threshold, among other factors.

If the selection process 300 determines at 312 that the number of consecutive “Poor” signal strengths has not been reached by the counter, then the selection process 300 may return to 304 to test the cellular signal strength again. If the system determines at 312 that the threshold number consecutive “Poor” cellular signal strength determinations has been reached by the counter (“X” number of consecutive poor cellular signal strengths) then the selection process 300 proceeds to 314.

At 314, the selection process 300 may determine whether there is at least a second SIM available to the IoT device. The second SIM may be the other of the first SIM 202 or the second SIM 204 of FIG. 2 that was not selected as the first SIM selection at 302. If the system determines that there is no second SIM available at step 314, then the selection process 300 may return to 304 to test the cellular signal strength of the first wireless carrier associated with the first SIM again. In some examples, whether the second SIM is available may be based on whether the IoT device includes a second SIM. In other examples, whether the second SIM is available may be based on whether there is a wireless network available associated with the second SIM of the IoT device.

If the selection process 300 determines that there is a second SIM available, then the selection process 300 may begin a handover procedure to handover the communications session to a second network via the second SIM 204 at 316. The second SIM 204 may be selected for the communications session. The handover process may include the selector 210 changing the SIM select control signal S from selecting the first SIM 202 to be operational to selecting the second SIM 204 to be operational. The selector 210 may switch the data signal from being provided to the first eSIM data signal input 242 of the first SIM 202 to being provided to the second eSIM data signal input 244 of the second SIM 204. In some examples, the SIM select control signal S may be set either high or low based on the output of the selection process 300. In some examples, the handover process maintains an uninterrupted communication session for the IoT device but may switch the network from a first network to a second network. In other examples, the handover process ends the previous communications session with the first network and establishes a separate, second communication session with the second network. As used herein, the terms “first communications session” and “second communications session” may refer to either the same communications session using two or more different SIMs or to two different communications sessions established using either the same SIM at different times or using two or more different SIMs.

At 318, the selection process 300 may determine whether it is possible to switch from using the first SIM 202 to using the second SIM 204. If it is not possible to switch from the first

SIM 202 to the second SIM 204, the selection process proceeds to 320 and outputs a telematic error message. The telematic error message may be provided to the first network or may be output at an output device of the IoT device. The selection process 300 may proceed back to 304, wherein the first communication session over the first network via the first SIM 202 may be maintained. At 304, the selection process 300 may continue to test the cellular signal strength of the first communication session associated with the first wireless carrier.

However, at 318, if the system determines that it is possible to switch to the second SIM, then the selection process 300 may find a “best” provider (for example, a second wireless carrier) at 322. The “best” provider may be a provider with a strongest signal strength, a largest coverage area, a lowest subscription cost, or the like. The selection of the “best” carrier at 322 may be additionally or alternatively based on, for example, a wireless carrier pre-associated with the selected SIM or may be selected from a list of available carriers. The selection among a list of available carriers may be, for example, based on eSIM supplier software logic associated with the selected SIM. The selected SIM card may include logic that controls the determination of a “best” carrier, and the determination may be static or dynamic. In one example, a wireless provider may select or otherwise rank wireless carriers on the eSIM supplier software logic related to pricing or other criteria, and the ranking may be static or may be changed over time. A wireless provider may provide access to multiple wireless carriers. For example, a general wireless subscription may be sold by the wireless provider that allows a SIM to have access to multiple wireless carriers.

The selection process 300 may connect to a “best” signal on a second network associated with the second wireless carrier at 324. The “best” signal may be based on one or more factors such as a strongest signal strength, one or more beamforming characteristics, on other criteria or may be based on availability of signals or a preferred signal, or the like. The selection process 300 may then return to step 304 to test the cellular signal strength of the second network that is now established with the second SIM 204. In an example, the selection process 300 at 322 and 324 may be performed within the second SIM 204, which may be, for example, an eSIM. In an example, the selection process 300 at 322 and 324 may be performed automatically, for example, upon selection and/or initialization of the second SIM 204.

The selection process 300 may then repeat from 304, with the second SIM being identified as a “first” SIM for the repetition of the selection process 300, and the “2^{nd} SIM” labeled at 314, 316, and 318 may be, for example, the original first SIM, or may be another SIM among the plurality of SIMs for examples with more than two SIMs. As such, after the second SIM connects, the IoT device may continue to use the second SIM until the connection is dropped or until the consecutive number of poor cell signal strengths is equal to the counter threshold (for example, until the second SIM fails at 312). If multiple SIMs fail at 312, the selection process 300 may set a restart timer for a predetermined period of time and restart the selection process 300. For example, if the cellular signal strength is determined to be “Poor” for all of the available SIMs (or a subset number of the SIMs), then a timer may be set to wait before the selection process 300 restarts. For example, a timer may be set for 5 minutes and then the selection process 300 may be restarted to attempt again with the first SIM and each subsequent SIM. In some aspects, the selection process 300 may utilize firmware to instruct a cellular modem which SIM to use without writing software on the SIM.

In some forms, a respective SIM among the plurality of SIMs may be associated with only one corresponding carrier, for example, VERIZON WIRELESS®. In another example, a respective SIM among the plurality of SIMs may be carrier independent. A carrier-independent SIM may have a list of carriers with which it is associated (for example, AT&T®, T-MOBILE®, etc.). An airtime subscription may be purchased from a wireless provider to associate the available SIMs with their respective wireless carriers. However, the carriers are not limited to the above examples.

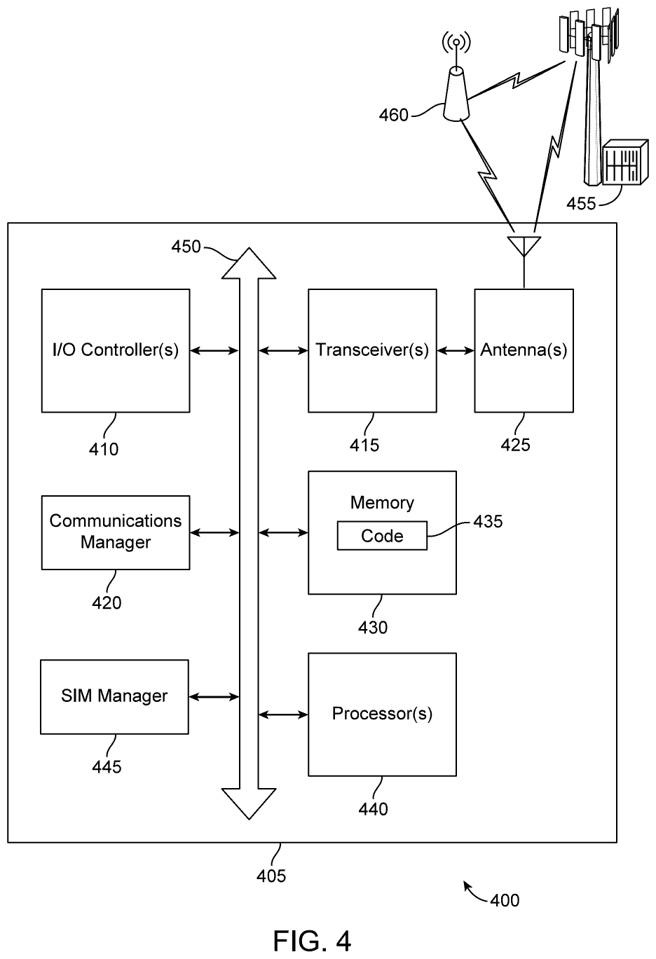

FIG. 4 shows a diagram of a system 400 including a device 405 that supports use of multiple SIM cards in an IoT device according to an example of the present disclosure. The device 405 may be an example of or include components of an IoT device, for example, the IoT device 140 of FIG. 1, as described herein. The device 405 may communicate (for example, wirelessly) with one or more other devices, such as a base station 455, an access point 460, or another device (for example, other network entities, user equipment, or a combination thereof). The device 405 may include components for bi-directional voice and data communications including components for transmitting and receiving communications, such as a communications manager 420, an input/output (I/O) controller, such as an I/O controller 410, one or more transceivers 415, one or more antennas 425, at least one memory 430, code 435, and at least one processor 440, for example, the processors 112 or 144 of FIG. 1. These components may be in electronic communication or otherwise coupled (for example, operatively, communicatively, functionally, electronically, electrically) via one or more buses 450 (for example, the eSIM card interface bus SIM_COM of FIG. 3). In some examples, the device 405 may be implemented within a material handling vehicle, such as the material handling vehicle 101 of FIG. 1.

The I/O controller 410 may manage input and output signals for the device 405. The I/O controller 410 may also manage peripherals not integrated into the device 405. In some cases, the I/O controller 410 may represent a physical connection or port to an external peripheral. In some cases, the I/O controller 410 may utilize an operating system such as iOS®, ANDROID®, MS-DOS®, MS-WINDOWS®, OS/2®, UNIX®, LINUX®, or another known operating system. Additionally, or alternatively, the I/O controller 410 may represent or interact with a modem, a keyboard, a mouse, a touchscreen, or a similar device. In some cases, the I/O controller 410 may be implemented as part of one or more processors, such as the at least one processor 440. In some cases, a user may interact with the device 405 via the I/O controller 410 or via hardware components controlled by the I/O controller 410.

In some cases, the device 405 may include a single antenna. However, in some other cases, the device 405 may have more than one antenna, which may be capable of concurrently transmitting or receiving multiple wireless transmissions. The one or more transceivers 415 may communicate bi-directionally via the one or more antennas 425 using wired or wireless links as described herein. For example, the one or more transceivers 415 may represent a wireless transceiver, and may communicate bi-directionally with another wireless transceiver. The one or more transceivers 415 may also include a modem to modulate the packets, to provide the modulated packets to one or more antennas 425 for transmission, and to demodulate packets received from the one or more antennas 425. The one or more transceivers 415, or the one or more transceivers 415 and the one or more antennas 425, may be an example of a transmitter, a receiver, or any combination thereof or component thereof. The one or more antennas 425 may communicate, for example, wirelessly, for example, with network entities, such as the base station 455 and/or the access point 460.

The at least one memory 430 may include random access memory (RAM) and read-only memory (ROM). The at least one memory 430 may store computer-readable, computer-executable, or processor-executable code, such as the code 435. The code 435 may include instructions that, when executed by the at least one processor 440, cause the device 405 to perform various functions described herein. The code 435 may be stored in a non-transitory computer-readable medium such as system memory or another type of memory. In some cases, the code 435 may not be directly executable by the at least one processor 440 but may cause a computer (for example, when compiled and executed) to perform functions described herein. In some cases, the at least one memory 430 may include, among other things, a basic I/O system (BIOS) which may control basic hardware or software operation such as the interaction with peripheral components or devices.

The at least one processor 440 may include one or more intelligent hardware devices (for example, one or more general-purpose processors, one or more digital signal processors (DSPs), one or more central processing units (CPUs), one or more graphics processing units (GPUs), one or more neural processing units (NPUs) (also referred to as neural network processors or deep learning processors (DLPs)), one or more microcontrollers, one or more application specific integrated circuits (ASICs), one or more field programmable gate arrays (FPGAs), one or more programmable logic devices (PLDs), discrete gate or transistor logic, one or more discrete hardware components, or any combination thereof. In some cases, the at least one processor 440 may be configured to operate a memory array using a memory controller. In some other cases, a memory controller may be integrated into the at least one processor 440. The at least one processor 440 may be configured to execute computer-readable instructions stored in a memory (for example, the at least one memory 430) to cause the device 405 to perform various functions (for example, functions or tasks supporting methods to switch between SIM cards based on signal strength or other factors). For example, the device 405 or a component of the device 405 may include at least one processor 440 and at least one memory 430 coupled with or to the at least one processor 440, the at least one processor 440 and the at least one memory 430 configured to perform various functions described herein. The at least one processor 440 may include, for example, at least one of the processors 112 or the one or more processors 144 of FIG. 1.

In some examples, the at least one processor 440 may include multiple processors and the at least one memory 430 may include multiple memories. One or more of the multiple processors may be coupled with one or more of the multiple memories, which may, individually or collectively, be configured to perform various functions described herein. In some examples, the at least one processor 440 may be a component of a processing system, which may refer to a system (such as a series) of machines, circuitry (including, for example, one or both of processor circuitry (which may include the at least one processor 440) and memory circuitry (which may include the at least one memory 430)), or components, that receives or obtains inputs and processes the inputs to produce, generate, or obtain a set of outputs. The processing system may be configured to perform one or more of the functions described herein. For example, the at least one processor 440 or a processing system including the at least one processor 440 may be configured to, configurable to, or operable to cause the device 405 to perform one or more of the functions described herein. Further, as described herein, being “configured to,” being “configurable to,” being “designed to,” being “adapted to,” and being “operable to” may be used interchangeably and may be associated with a capability, when executing code 435 (for example, processor-executable code) stored in the at least one memory 430 or otherwise, to perform one or more of the functions described herein.

The communications manager 420 may support wireless communications in accordance with examples as disclosed herein. For example, the communications manager 420 is capable of, configured to, or operable to support a means for an IoT device to switch among multiple SIMs while establishing or maintaining wireless communication sessions. The SIMs may be controlled by a SIM manager 445, which may be, for example, the communication circuit 200 of FIG. 2. The communications manager 420 may include, for example, the communication circuit 142 of FIG. 1.

The communications manager 420 may obtain a first cellular signal strength associated with a first wireless communications session over a first network via a first wireless carrier and a first SIM of the plurality of SIMs. The communications manager may reset a counter when the first cellular signal strength is equal to or above a threshold cellular signal strength and incrementing the counter when the first cellular signal strength is below the threshold cellular signal strength.

The communications manager 420 may determine whether the first cellular signal strength associated with the first network is greater than or equal to the threshold cellular signal strength. The communications manager 420 may increment the counter when the first cellular signal strength is below the threshold cellular signal strength by determining that the counter is below the counter threshold and obtaining a second cellular signal strength associated with the first wireless communications session based at least in part on the counter being below the counter threshold. The communications manager 420 may determine that the counter is below the counter threshold at a first time, and increment the counter when the first cellular signal strength is below the threshold cellular signal strength by determining that the counter is below the counter threshold at a second time later than the first time and obtaining a third cellular signal strength associated with the first wireless communications session over the first network based at least in part on the counter being below the counter threshold.

The SIM manager 445 may maintain the first wireless communications session using the first SIM when the counter is below a counter threshold and determining availability of a second SIM of the plurality of SIMs when the counter is equal to the counter threshold. The SIM manager 445 may initiate a process to establish a second wireless communications session over a second network using the second SIM when the second SIM is available, and the counter is equal to the counter threshold.

In some examples, the SIM manager 445 may determining that a handover to the second wireless communications session over the second network using the second SIM is not possible at a first time. When the handover is not possible, the SIM manager 445 may output an error notification indicating that the handover to the second wireless communications session over the second network using the second SIM is not possible at the first time. The I/O controller 410 may output the error notification, which may be a visual, audio, or haptic alert.

In other instances, in initiating the process to establish the second wireless communications session over the second network using the second SIM, the SIM manager 445 may determining that the handover to the second wireless communications session over the second network using the second SIM is possible at a second time, wherein the second time is later than the first time. The SIM manager 445 may establish the second wireless communications session over the second network using the second SIM when the second SIM based on the handover to the second wireless communications session being possible at the second time.

In further examples, the SIM manager 445 may establish the first wireless communications session with the first network using the first SIM and register the first SIM with the first network.

In some examples, obtaining the first cellular signal strength further includes waiting for an allotted time to expire before obtaining the first cellular signal strength, the allotted time being a period of time associated with establishing the first wireless communications session with the first network. The allotted time may be 2.5 minutes, or it may be another time duration.

In some examples where the first wireless carrier is of a plurality of wireless carriers, initiating the process to establish the second wireless communications session over the second network using the second SIM may further include selecting a second wireless carrier from the plurality of wireless carriers based at least in part on a one or more of a predetermined selection, an arbitrary selection, an availability of each of the plurality of wireless carriers, and a preferred roaming list associated with the plurality of wireless carriers. In some examples, each of the plurality of SIMs is an embedded SIM. In other instances, a selection order of the plurality of SIMs may be arbitrary.

In some examples, the communications manager 420 and the SIM manager 445 may be configured to perform various operations (for example, receiving, monitoring, transmitting) using or otherwise in cooperation with the one or more transceivers 415, the one or more antennas 425, or any combination thereof. Although the communications manager 420 and the SIM manager 445 are illustrated as a separate components, in some examples, one or more functions described with reference to the communications manager 420 and the SIM manager 445 may be supported by or performed by the at least one processor 440, the at least one memory 430, the code 435, a communication circuit 142 or 200, or any combination thereof. For example, the code 435 may include instructions executable by the at least one processor 440 to cause the device 405 to perform various aspects of switching SIMs as described herein, or the at least one processor 440 and the at least one memory 430 may be otherwise configured to, individually or collectively, perform or support such operations.

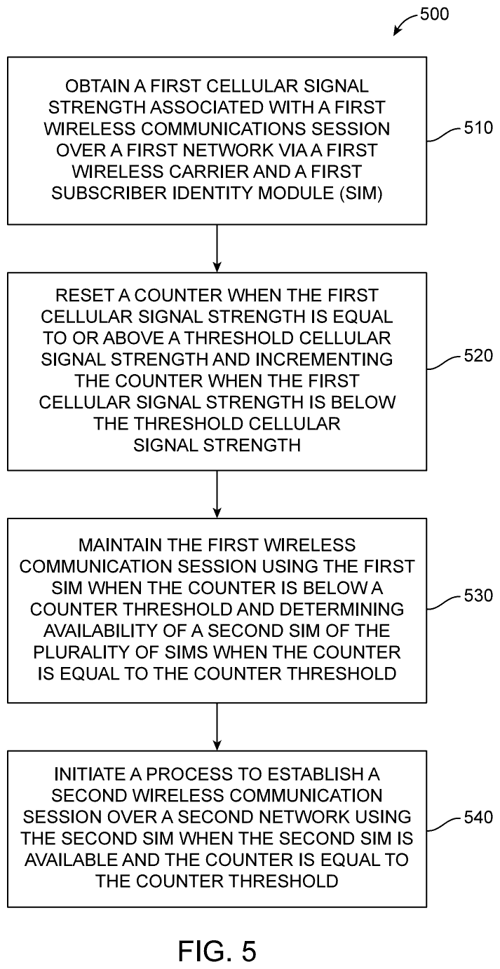

With reference to FIG. 5, a method 500 is provided for switching among a plurality of subscriber identity modules in an Internet of Things device. The operations of the method 500 may be implemented by an IoT device or its components as described herein. For example, the operations of the method 500 may be performed by an IoT device 140, a communication circuit 142 or 200, a material handling vehicle 101, or a device 405, as described with reference to FIGS. 1 through 4. In some examples, an IoT device may execute a set of instructions to control the functional elements of the network entity to perform the described functions. Additionally, or alternatively, the IoT device may perform aspects of the described functions using special-purpose hardware.

The method 500 may include obtaining a first cellular signal strength associated with a first wireless communications session over a first network associated with a first wireless carrier associated with a first SIM of the plurality of SIMs at 510. 510 may be performed, for example, by the communications manager 420, or the one or more processors 440 of FIG. 4, or by the communication circuit 142 or 200 of FIGS. 1 and 2.

The method 500 may further include resetting a counter when the first cellular signal strength is equal to or above a threshold cellular signal strength and incrementing the counter when the first cellular signal strength is below the threshold cellular signal strength at 520. 520 may be performed, for example, by the communications manager 420, or the one or more processors 440 of FIG. 4, or by the communication circuit 142 or 200 of FIGS. 1 and 2.

The method 500 may further include maintaining the first wireless communication session using the first SIM when the counter is below a counter threshold and determining availability of a second SIM of the plurality of SIMs when the counter is equal to the counter threshold at 530. 530 may be performed, for example, by the communications manager 420, or the one or more processors 440 of FIG. 4, or by the communication circuit 142 or 200 of FIGS. 1 and 2.

The method 500 may further include initiating a process to establish a second wireless communication session over a second network using the second SIM when the second SIM is available, and the counter is equal to the counter threshold in operation 520. Operation 540 may be performed, for example, by the communications manager 420, or the one or more processors 440 of FIG. 4, or by the communication circuit 142 or 200 of FIGS. 1 and 2.

In some examples, the method 500 may further include determining whether the first cellular signal strength associated with the first network is greater than or equal to the threshold cellular signal strength, which may be performed, for example, by the communications manager 420, or the one or more processors 440 of FIG. 4, or by the communication circuit 142 or 200 of FIGS. 1 and 2.

In some examples of incrementing the counter when the first cellular signal strength is below the threshold cellular signal strength, the method 500 may further include determining that the counter is below the counter threshold and obtaining a second cellular signal strength associated with the first wireless communications session based at least in part on the counter being below the counter threshold. The counter may be included, for example, in the communications manager 420, the one or more processors 440, or the SIM manager 445, and may be stored in memory 430. In some examples, determining that the counter is below the counter threshold is determined at a first time, while incrementing the counter when the first cellular signal strength is below the threshold cellular signal strength may further include determining that the counter is below the counter threshold at a second time. The second time may be after the first time. In some examples, the method 500 may include determining a third cellular signal strength associated with the first wireless communications session over the first network based at least in part on the counter being below the counter threshold. These operations may be performed by, for example, the communications manager 420, the one or more processors 440, or the SIM manager 445,

In other examples, other configurations are possible. For example, those of skill in the art will recognize, according to the principles and concepts disclosed herein, that various combinations, sub-combinations, and substitutions of the components discussed above may provide appropriate control for a variety of different configurations of IoT devices, material handling vehicles, work machines, operator control systems, automotive vehicles, consumer electronics, and so on, for a variety of applications. All trademarks used herein are the property of their respective owners.

Information and signals described herein may be represented using any of a variety of different technologies and techniques. For example, data, instructions, commands, information, signals, bits, symbols, and chips that may be referenced throughout the description may be represented by electromagnetic waves, voltages, currents, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other PLD, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by one or more processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” and “and/or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B. For example, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), identifying, ascertaining, and the like. Also, “determining” can include receiving (for example, receiving information), accessing (for example, accessing data stored in memory), retrieving, and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

In other instances, other configurations of the systems and methods described herein are possible. For example, those of skill in the art will recognize, according to the principles and concepts disclosed herein, that various combinations, sub-combinations, and substitutions of the components discussed above can provide appropriate control for a variety of different configurations of robotic platforms for a variety of applications.

The previous description of the disclosed examples is provided to enable any person skilled in the art to make or use the invention. Various modifications to these examples will be readily apparent to those skilled in the art, and the generic principles defined herein may be applied to other examples without departing from the spirit or scope of the invention. Thus, the invention is not intended to be limited to the examples shown herein but is to be accorded the widest scope consistent with the principles and novel features disclosed herein.

What is claimed is:

1. A communication circuit for operating a plurality of embedded subscriber identity modules (eSIMs), comprising:
a first eSIM comprising at least a first eSIM data signal input;
a second eSIM comprising at least a second eSIM data signal input;
an eSIM card interface bus adapted to provide signals to and from the first eSIM and the second eSIM, the eSIM card interface bus comprising a data line adapted to receive a data signal;
an eSIM select line adapted to receive an eSIM select control signal to select between using the first eSIM or the second eSIM to communicate with at least one wireless network; and
a selector operatively connected to the eSIM select line, the selector being associated with a first channel and a second channel, the selector adapted to:
switch a connection of the data signal between the first channel and the second channel to provide the data signal to the first eSIM data signal input and the second eSIM data signal input based at least in part on the eSIM select control signal.

2. The communication circuit of claim 1, further comprising:
a logic level shifter adapted to condition the eSIM select control signal.

3. The communication circuit of claim 1, further comprising:
a resistor-transistor logic circuit adapted to condition the eSIM select control signal.

4. The communication circuit of claim 1, wherein:
the first eSIM further comprises:
a first eSIM reset signal input; and
a first eSIM clock signal input;
the second eSIM further comprises:
a second eSIM reset signal input; and
a second eSIM clock signal input;
the eSIM card interface bus further comprises:
a reset signal line adapted to receive a reset signal; and
a clock line adapted to receive a clock signal; and
each of the eSIM card interface bus, the first eSIM, and the second eSIM is adapted to respectively receive the reset signal and the clock signal.

5. The communication circuit of claim 1, wherein the first eSIM and the second eSIM are each a machine-to-machine form factor eSIM.

6. A method of switching among a plurality of subscriber identity modules (SIMs) in an Internet of Things (IoT) device, the method comprising:
obtaining a first cellular signal strength associated with a first wireless communications session over a first network via a first wireless carrier and a first SIM of the plurality of SIMs;
resetting a counter when the first cellular signal strength is equal to or above a threshold cellular signal strength and incrementing the counter when the first cellular signal strength is below the threshold cellular signal strength;
maintaining the first wireless communications session using the first SIM when the counter is below a counter threshold and determining availability of a second SIM of the plurality of SIMs when the counter is equal to the counter threshold; and
initiating a process to establish a second wireless communications session over a second network using the second SIM when the second SIM is available and the counter is equal to the counter threshold.

7. The method of claim 6, further comprising:
determining whether the first cellular signal strength associated with the first network is greater than or equal to the threshold cellular signal strength.

8. The method of claim 6, wherein incrementing the counter when the first cellular signal strength is below the threshold cellular signal strength further comprises:
determining that the counter is below the counter threshold; and
obtaining a second cellular signal strength associated with the first wireless communications session based at least in part on the counter being below the counter threshold.

9. The method of claim 8, wherein determining that the counter is below the counter threshold is at a first time, and wherein incrementing the counter when the first cellular signal strength is below the threshold cellular signal strength further comprises:
determining that the counter is below the counter threshold at a second time later than the first time; and
obtaining a third cellular signal strength associated with the first wireless communications session over the first network based at least in part on the counter being below the counter threshold.

10. The method of claim 6, wherein initiating the process to establish the second wireless communications session over the second network using the second SIM further comprises:
determining that a handover to the second wireless communications session over the second network using the second SIM is not possible at a first time; and
outputting an error notification indicating that the handover to the second wireless communications session over the second network using the second SIM is not possible at the first time.

11. The method of claim 10, wherein initiating the process to establish the second wireless communications session over the second network using the second SIM further comprises:
determining that the handover to the second wireless communications session over the second network using the second SIM is possible at a second time, wherein the second time is later than the first time; and
establishing the second wireless communications session over the second network using the second SIM when the second SIM based on the handover to the second wireless communications session being possible at the second time.

12. The method of claim 6, further comprising:
establishing the first wireless communications session with the first network using the first SIM; and
registering the first SIM with the first network.

13. The method of claim 6, wherein obtaining the first cellular signal strength further comprises:
waiting for an allotted time to expire before obtaining the first cellular signal strength, the allotted time being a period of time associated with establishing the first wireless communications session with the first network.

14. The method of claim 13, wherein the allotted time is 2.5 minutes.

15. The method of claim 6, wherein:
the first wireless carrier is of a plurality of wireless carriers; and
initiating the process to establish the second wireless communications session over the second network using the second SIM further comprises selecting a second wireless carrier from the plurality of wireless carriers based at least in part on a one or more of a predetermined selection, an arbitrary selection, an availability of each of the plurality of wireless carriers, and a preferred roaming list associated with the plurality of wireless carriers.

16. The method of claim 6, wherein each of the plurality of SIMs is an embedded SIM (eSIM).

17. The method of claim 6, wherein a selection order of the plurality of SIMs is arbitrary.

18. An Internet of Things (IOT) device, comprising:
at least one transceiver adapted to transmit and receive wireless communication signals over at least one wireless communications session; and
a communication circuit in communication with the at least one transceiver, wherein the communication circuit is adapted to operate a plurality of embedded subscriber identity modules (eSIMs) associated with the at least one wireless communications session, the communication circuit comprising:
a first eSIM comprising at least a first eSIM data signal input;
a second eSIM comprising at least a second eSIM data signal input;
an eSIM card interface bus adapted to provide signals to and from the first eSIM and the second eSIM, the eSIM card interface bus comprising a data line adapted to receive a data signal;
an eSIM select line adapted to receive an eSIM select control signal adapted to select between using the first eSIM or the second eSIM to communicate with at least one wireless network; and
a selector operatively connected to the eSIM select line, the selector being associated with a first channel and a second channel, the selector adapted to:
switch a connection of the data signal between the first channel and the second channel to provide the data signal to the first eSIM data signal input and the second eSIM data signal input based at least in part on the eSIM select control signal.

19. The IoT device of claim 18, wherein:
the first eSIM further comprises:
a first eSIM reset signal input; and
a first eSIM clock signal input;
the second eSIM further comprises:
a second eSIM reset signal input; and
a second eSIM clock signal input;
the eSIM card interface bus further comprises:
a reset signal line adapted to receive a reset signal; and
a clock line adapted to receive a clock signal; and
each of the eSIM card interface bus, the first eSIM, and the second eSIM is adapted to respectively receive the reset signal and the clock signal.

20. The loT device of claim 18, wherein the loT device comprises a material handling vchiclc.
